(19) United States
(12) Patent Application Publication
(10) Pub. No.: US 2002/0054429 A1
(43) Pub. Date: May 9, 2002

(54) Arrangement for visual and quantitative three-dimensional examination of specimens and stereomicroscope therefor

(76) Inventors: Johann Engelhardt, Bad Schoenborn (DE); Werner Knebel, Kronau (DE)

Correspondence Address: DAVIDSON, DAVIDSON & KAPPEL, LLC, 485 SEVENTH AVENUE, 14TH FLOOR, NEW YORK, NY, 10018, US

(21) Appl. No.: 09/992,075

(22) Filed: Nov. 6, 2001

(30) Foreign Application Priority Data
Nov. 8, 2000 (DE) 100 55 176.9

(51) Int. Cl. G02B 21/00; G02B 21/22

(52) U.S. Cl. 359/368; 359/376; 359/382

(57) ABSTRACT

An arrangement for visual and quantitative three-dimensional examination of specimens, having a stereomicroscope (2). The stereomicroscope defines a first and a second observation beam path (4, 5), by way of which a specimen (6) to be examined can be visually observed. A confocal scanning device (1) is connected to the stereomicroscope (1) in such a way that a scanning beam path (3) defined by the confocal scanning device (1) scans the specimen (6) that is to be examined and in that context acquires data for a three-dimensional visual depiction of the specimen (6).

### CROSS REFERENCE TO RELATED APPLICATIONS

This invention claims priority of the German patent application 100 55 176.9 which is incorporated by reference herein.

### FIELD OF THE INVENTION

The invention concerns an arrangement for visual and quantitative three-dimensional examination of specimens.

The invention concerns as well a stereomicroscope for visual and quantitative three-dimensional examination of specimens.

### BACKGROUND OF THE INVENTION

The general configuration of a stereo microscope is known from German Design Application 400 04 640.7. Several embodiments of a stereomicroscope are presented. The stereomicroscope allows visual three-dimensional observation of a specimen by the observer. If the image is acquired, for example, with a CCD camera, the observer then obtains only a two-dimensional image.

German Unexamined Application DE 196 32 637 discloses a method for generating parallactic sectional image stacks for high-resolution stereomicroscopy. By means of the method it is possible to create 3D animations of the three-dimensional object by generating a series of sectional image stacks or sectional image stack pairs. A sectional image stack is produced by directing the depth-of-focus range of the microscope objective through the specimen in discrete steps along the optical axis. A sectional image stack is thereby obtained. From the sectional image stack, respective parallactic sectional image pairs are formed that correspond to the parallactic angle for stereoscopic vision. Three-dimensional depiction of the images on a display would, however, probably require considerable calculation effort.

The general configuration of a confocal scanning microscope having a scanning device is known from U.S. Pat. No. 4,863,266. The scanning microscope allows resolution and contrast to be enhanced in three dimensions. It is also possible to obtain 3D information from the object. Unfortunately the apparatus does not allow visual 3D observation of the specimen to be examined.

The article “Confocal imaging for 3-D digital microscopy” by Kjell Carlsson and Niels Åslund, in Applied Optics, Vol. 26(16), pp. 3232-3238, deals with a method for three-dimensional viewing of specimens with a confocal microscope. Prior to the scanning operation, the user can observe the specimen with conventional microscopic methods. For the three-dimensional view, multiple planes in the specimen along the optical axis are imaged. The stack of digital images from the various planes yields a three-dimensional matrix of the specimen. A wide variety of processes can be performed thereon in a computer. This method, too, does not permit visual three-dimensional observation of the specimen and simultaneous acquisition of specimen data using a confocal scanning device.

### SUMMARY OF THE INVENTION

It is the object of the invention to create an arrangement that makes possible, alongside visual three-dimensional observation of the specimen, quantitative three-dimensional analysis of the specimen to be examined. In addition, the invention intends to make possible high-quality three-dimensional depiction of a specimen, in that context reducing the calculation effort or other mathematical processes that require a considerable expenditure of time.

The stated object is achieved by an arrangement which comprises:

a stereomicroscope that defines a first and a second observation beam path, and

a confocal scanning device is connected to the stereomicroscope thereby providing a scanning beam path wherein the confocal scanning device scans a specimen that is to be examined and acquires data for a three-dimensional visual depiction of the specimen.

It is an other object of the invention to provide a stereomicroscope which allows an optical observation and a examination with a scanning beam in parallel.

The above object is achieved by a stereomicroscope for visual and quantitative three-dimensional examination of specimens which comprises:

an objective

a first and a second eyepiece, wherein the objective and the first and second eyepiece defines a first and a second observation beam path, and

a confocal scanning device is connected to the stereomicroscope thereby providing a scanning beam path wherein the confocal scanning device scans a specimen that is to be examined and acquires data for a three-dimensional visual depiction of the specimen.

One advantage of the invention is to make possible both visual and confocal scanning, with a stereomicroscope, of the specimen to be examined. It is necessary in this context for a confocal scanning device to be connected to the stereomicroscope in such a way that a scanning beam path defined by the confocal scanning device scans a specimen that is to be examined, and in that context acquires data for a three-dimensional visual depiction of the specimen. In stereomicroscopy it is possible in this context to dispense with stereophotography, which creates two images of the object from different viewing angles; the three-dimensional images thereby obtained often are of disappointing quality. These images are moreover laborious to produce, and require considerable complex equipment for observation. By way of the confocal scanning device connected to a stereomicroscope it is possible to create multiple images in succession, each in different planes of a specimen. These data are stored, for example, in a memory of a computer and can be employed at any time for quantitative evaluations, e.g. distance measurements in three dimensions, particle counts in all three spatial directions, or the distribution of certain chemical elements in the three spatial directions. The invention not only simplifies the analysis of specimens to be examined, but also greatly improves it in terms of results.

### BRIEF DESCRIPTION OF THE DRAWINGS

The subject matter of the invention is depicted schematically in the drawings and will be described below with reference to the Figures, in which:

FIG. 1 schematically depicts the coupling of the confocal scanning device by way of the camera port; and

FIG. 2 schematically depicts a stereomicroscope in which the scanning beam path is coupled directly into an observation beam path.

### DETAILED DESCRIPTION OF THE INVENTION

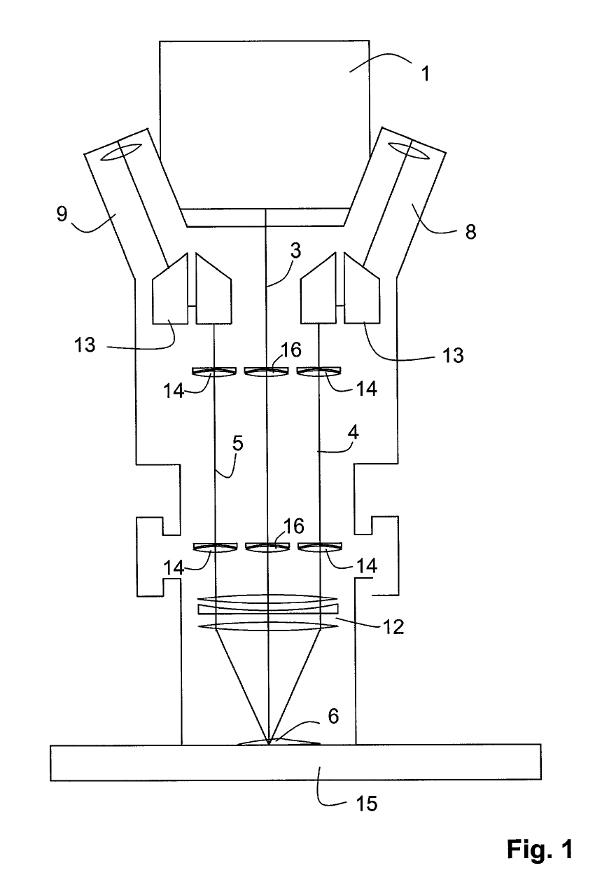

FIG. 1 schematically depicts the coupling of a confocal scanning device 1 by way of the camera port (not depicted) of a stereomicroscope 2. Stereomicroscope 2 possesses a first and a second eyepiece 8 and 9, arranged respectively in the first and second observation beam path 4 and 5. A reflecting prism 13 is inserted into each observation beam path 4 and 5 and guides the observation beam path correspondingly in stereomicroscope 2. Also provided in first and second observation beam paths 4 and 5 are several tube lenses 14. Arranged after tube lenses 14 is an objective 12 that images first and second observation beam paths 4 and 5 simultaneously onto a specimen 6. Specimen 6 can be located, for example, on a specimen support stage 15. Scanning device 1 defines a scanning beam path 3 that is also imaged by objective 12 onto the specimen. Inserted before objective 12 in scanning beam path 3 are further lenses 16 that guide scanning beam path 3 parallel to first and second observation beam paths 4 and 5 as far as objective 12. Also to be noted is the fact that the observer must be protected from the illuminating laser light of the scanning beam reflected from the specimen. For this purpose, for example, suitable filters that protect the user from the observing light beam can be provided.

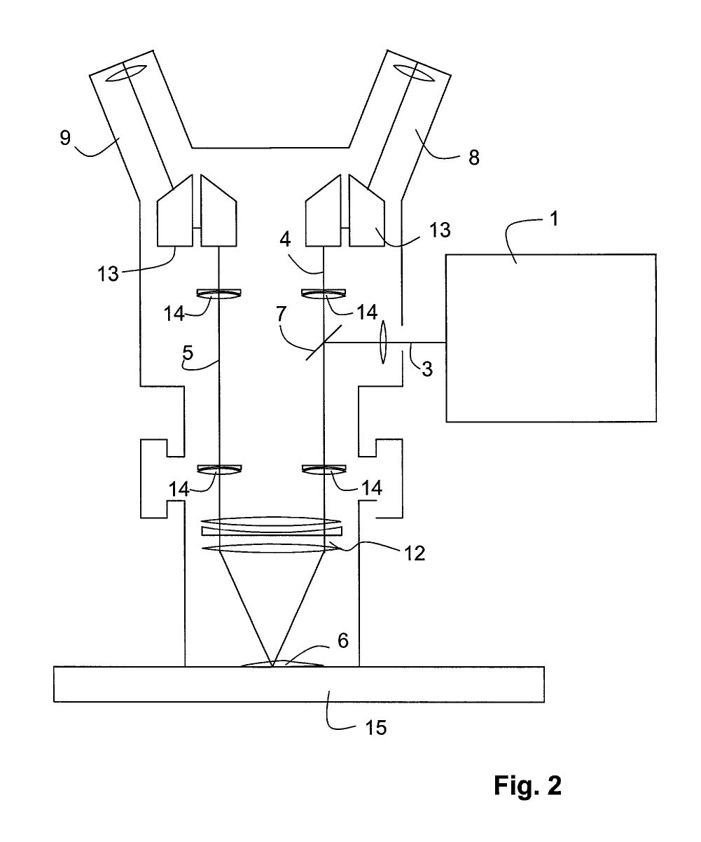

A further embodiment of the invention is depicted in FIG. 2. All elements of FIG. 2 that are identical to the elements of FIG. 1 are labeled with the same reference character. In this exemplary embodiment, scanning device 1 is arranged with respect to the scanning microscope in such a way that scanning beam path 3 can be coupled directly into one of the two observation beam paths 4 and 5. For that purpose, an optical coupling-in element 7 that guides scanning beam path 3 into an observation beam path is provided in one of observation beam paths 4 or 5. In that context, scanning beam path 3 also passes through at least one of tube lenses 14. Scanning beam path 3 and observation beam paths 4 and 5 are imaged by objective 12 onto specimen 6. Optical coupling-in element 7 is coated in order to protect the user from the illuminating laser light of the scanning beam reflected from the specimen.

The manner of operation and the configuration of the scanning device are described below only for the sake of completeness, since a scanning device is sufficiently known from the existing art. In confocal scanning microscopy, a specimen is scanned with a light beam. A confocal scanner or a scanning device generally comprises a light source, a focusing optical system with which the light of the light source is focused onto the onto a pinhole, a scanning mechanism for beam control, a detection pinhole, and detectors for detecting the detected and fluorescent light. Objective 12 is needed in order to image the scanning beam onto specimen 6. As is evident from the exemplary embodiment of FIG. 2, an optical coupling-in element 7 (beam splitter) is also needed in order to couple scanning beam path 3 into observation beam path 4 or 5. The focus of the scanning beam is moved, generally by tilting two mirrors, in a plane within specimen 6, the deflection axes usually being perpendicular to one another so that one mirror deflects in the X and the other in the Y direction. Tilting of the mirrors is brought about, for example, with the aid of galvanometer positioning elements. The fluorescent or reflected light coming from the specimen passes back via the same scanning mirrors

The invention was described with reference to a particular embodiment and is focused onto the detection pinhole behind which detectors, usually photomultipliers, are located. Detected light that does not derive directly from the focus region takes a different light path and does not pass through the detection pinhole, so that a point datum is obtained that results, by scanning of the specimen, in a three-dimensional image. The principle itself rules out depth-of-focus problems.

Located downstream from scanning device 1 is a corresponding electronic system (not depicted) that quantitatively analyzes the three-dimensional image of the specimen. Multiple planes in a specimen are scanned in succession, and the stacks thereby obtained are analyzed in corresponding fashion. The analysis can also be performed, for example, with a computer (not depicted) and a corresponding computer software program.

The invention was described with reference to a particular embodiment. It is self-evident, however, that changes and modifications can be made without thereby leaving the range of protection of the claims recited hereinafter.

What is claimed is:

1. An arrangement for visual and quantitative three-dimensional examination of specimens, comprising:
a stereomicroscope that defines a first and a second observation beam path, and
a confocal scanning device is connected to the stereomicroscope thereby providing a scanning beam path wherein the confocal scanning device scans a specimen that is to be examined and acquires data for a three-dimensional visual depiction of the specimen.

2. The arrangement as defined in claim 1, wherein the confocal scanning device is mounted on the stereomicroscope so that the scanning beam path can be coupled into the first or into the second observation beam path.

3. The arrangement as defined in claim 2, wherein an optical coupling-in element which couples the scanning beam path into at least one of the observation beam paths is provided.

4. The arrangement as defined in claim 1, wherein the stereomicroscope is equipped with a camera port at which the confocal scanning device couples the scanning beam path into the stereomicroscope.

5. The arrangement as defined in claim 1, wherein the first and second illuminating beam path and the scanning beam path are together imaged by an objective of the stereomicroscope onto the specimen to be examined.

6. The arrangement as defined in claim 1, wherein the confocal scanning device is connected to a computer that analyzes the image data acquired by the confocal scanning device and displays them on a display.

7. A stereomicroscope for visual and quantitative three-dimensional examination of specimens, comprising:
an objective
a first and a second eyepiece, wherein the objective and the first and second eyepiece defines a first and a second observation beam path, and
a confocal scanning device is connected to the stereomicroscope thereby providing a scanning beam path wherein the confocal scanning device scans a specimen that is to be examined and acquires data for a three-dimensional visual depiction of the specimen.

8. The stereomicroscope as defined in claim 7, wherein scanning beam path provided by the confocal scanning device scans the specimen though the objective.

9. The stereomicroscope as defined in claim 8, wherein an optical coupling-in element which couples the scanning beam path into at least one of the observation beam paths is provided.

10. The stereomicroscope as defined in claim 8, wherein a camera port is provided at which the confocal scanning device is coupled to the stereomicroscope and a further lens is provided before the objective to guide the scanning beam path parallel to observation beam paths.
